(19) United States
(12) Patent Application Publication
(10) Pub. No.: US 2005/0115879 A1
(43) Pub. Date: Jun. 2, 2005

(54) Water filter and the production method therefor

(76) Inventors: Stanislav Mikhaylovich Kochergin, S. Peterburg (RU); Nikolai Romanovich Grebenschikov, S. Peterburg (RU); Valeri Mansurovich Safin, S. Petersburg (RU)

Correspondence Address: Ilya Zborovsky, 6 Schoolhouse Way, Dix Hills, NY, 11746, US

(21) Appl. No.: 10/506,754

(22) PCT Filed: Sep. 3, 2002
(86) PCT No.: PCT/RU02/00417

(51) Int. Cl. B01D 37/02; C08J 5/20

(52) U.S. Cl. 210/193; 210/506; 521/27

(57) ABSTRACT

A water filter has a body provided with an inlet, an outlet and a drain pipe provided with lock valves and a main filtering element composed of an ion-exchange material and having input and output surfaces for filtrated liquid, wherein the ion-exchange material is embodied in such a way that it is voluminous, has a required shape, is reinforced with a rigid reinforcement which is fixed to a perforated support, and forms a continuous porous frame from sphero colloids having required pore sizes which are defined by required cleaning parameters, the volume of the filtering mass of the element material being calculated according to mathematical expressions, and the input surface of the main filtering element is coated with an additional filtering and correcting layer of a fine substance introduced in the form of a powder through a loading valve in the cavity of the body in a filtered liquid flow deposited on the input surface of the main filtering element and dynamically retained by ram pressure of liquid, with the powder granule sizes being higher than the pores of the pores of the ion-exchange material, and the volume thereof corresponding to the shape of the main filtering element and defined according to mathematical expressions.

### AREA OF ENGINEERING

The invention relates to water purification devices, in particular, for potable water, by means of mechanical and ion-exchange purification as well as to methods of their manufacture.

### PREVIOUS ENGINEERING LEVEL

It is known that there is a filter for an additional purification of potable tap water [1] containing a cylindrical housing, a sorption filtration element located inside the housing and a lock fastening the device on a tap; at that the filtration element from resorcin-formaldehyde resin is made in the form of a cup located coaxially inside the housing with a gap; in addition, the cup wall thickness is ⅔ of its diameter, and the detachable outlet pipe and the inlet valve equipped with a locking nut are located at an angle being not less than 45° to the filter housing. Here, the ratio of the internal diameter of the housing to the outer diameter of the filtration element is made equal to 1:0.75+0.85.

A drawback of the device is that the cup from ion-exchange resorcin-formaldehyde resin does not have a sufficient mechanical strength, the cup pore size is not controlled and the main thing is that it is not protected against sudden emissions of contaminated water, which leads to immediate clogging of the pores and poisoning of the flirtation element. Its regeneration is impeded.

It is known that there is a method for the production of a micropore filter by treating a film from polyethylene-terephthalate by a solution of the water-acetone mixture with the acetone concentration of 40-50 vol. % [2]. Its drawback is that it has no selectivity and the sorption ability of the filtration product in respect to polyvalent cations of magnesium, calcium, aluminium, zinc, cadmium, manganese and iron as well as that it does not allow to control the filter material pore size during the fitter manufacture process.

It is known that there is a method for the, production of moulded materials based on urea-formaldehyde acid [3] including polycondensation of urea and formaldehyde in a water medium and moulding; at that the polycondensation of urea and formaldehyde and moulding of the resin being generated are carried out by means of holding of a water solution of urea, formaldehyde and an acidic catalyst with their mass ratio being equal to 1:(0.5-1.0):(0.01-0.12) respectively and the urea concentration of 250-600 g/l in the static conditions in a leak-tight mould during 10-50 minutes at 15-25° C. and for the production of a porous moulded material the urea is used with the solution concentration of 250-400 g/l. In order to secure mechanical strength, resorcin is added in the amount of 10-15% of the urea mass.

The material obtained by this method is sufficiently cheap but its mechanical strength is low for its use as a filter for water.

The theoretical justification of ion-exchange processes is set forth in the book of [4].

It is known that there are Geyser filters of various modifications for the purification of potable tap water, for example, Geyser-32 [5]. Their distinctive ability is the availability of an ion-exchange filtration element (elements) installed in the housing and based on resorcin-formaldehyde resin, with a possibility of its regeneration by the method of washing by a back water flow and purging by compressed air (up to 7 kgf/cm²).

Its drawback is that it is also susceptible to clogging by sudden emissions of contaminated water, which leads to poisoning of the ion-exchange element.

Nevertheless, by its design and the materials being used, it is mostly close to the technical essence of the device being proposed and can serve as its prototype.

### DISCLOSURE OF INVENTION

The task of this device is to provide a possibility of regulation of the filtration ability of the filtration element for various purification degrees; in addition, it has an increased strength and it is protected from poisoning at the moment of sudden emissions of strongly contaminated water as well as its correction depending upon what water is contaminated with and what degree of purification is required to achieve.

The problem stated above is solved by selecting a size of the filtration element pores for the required purification degree bearing in mind that the size significantly influences on the filter performance. To this end, there is a filter for water containing a housing equipped with inlet, outlet and drain branch pipes with corresponding shutoff valves and the main filtration element made from an ion-exchange material and having, the inlet and outlet surfaces for the liquid being filtered. In doing so, the ion-exchange material of the main filtration element is made to be volumetric, of the required geometrical shape, it is armoured by a load-bearing reinforcement attached to a perforated support and it constitutes a continuous porous framework from microglobules with pores of the required size. The liquid flow-rate and the rate of filtration through a flat filter is determined by the following dependencies:

$$Q = \frac{{kSh}_{v}}{L} ; W = kJ ;$$

where k is the empirical coefficient for the filtration material of the inlet surface, mm²/s;
S is the area of the inlet surface of the filter, mm²;
hᵥ is the pressure head being lost from the inlet surface of Sᵢₙ to the outlet surface of Sₒᵤₜ, kg/mm²;
L is the filter layer thickness, mm;

$$J = \frac{{h}_{r}}{L}$$

is the head gradient (the value of head drop per a unit path length), kg/mm².

For a filter in the form of a hollow cylinder, the ratios remain as before, but in the above-mentioned equation Sₒᵤₜ, the outlet surface area, should be taken as S. The comparison of objects for the flat and cylindrical filters

$$\frac{{V}_{}}{{V}_{cyl}} = \frac{d}{L + d} ;$$

provided equal thickness (L) of the filtration layer and other equal conditions, shows that the flat filter has a lesser volume of the filtration material mass.

It is evident that from the point of view of the material consumption, the flat filter is more beneficial than the cylindrical one and the more so than the conical filter, as it has a lesser volume.

The drop of the pressure head per a unit path length (J_{fl}) is constant with the flat filter, and for the cylindrical filter the head gradient (J_{cyi}) sharply grows from the inlet surface to the outlet surface (taking the outer cylinder surface as the inlet surface). It is caused by a decrease of the tree cross-sectional area of the filter with the liquid motion from the periphery to the centre. But at the same time the velocity of liquid at the cylindrical filter inlet is far less than that for the flat filter. This velocity decrease improves the ion exchange and sorption parameters. The contaminant particles settle in the outer layers of the filter and on its protection layer, which creates prerequisites for a better filter regeneration.

The authors have proposed the following formulae for the calculation of required filter volumes:

$${V}_{} = \frac{Q \cdot L}{k \cdot {h}_{v}}$$

—for the flat filter;

$${V}_{cyl} = \frac{Q \cdot {L}^{2} ( L + d )}{k \cdot {h}_{v} \cdot d}$$

—for the hollow cylindrical filter;

$${V}_{co n} = \frac{Q \cdot {L}^{2} ( 2 L + {d}_{k} + {D}_{k} )}{k \cdot {h}_{v} ( {d}_{k} + {D}_{k} )}$$

—for the conic filter;
where Q is the required flow-rate of the liquid being purified, kg/s;
L is the filtering layer thickness, mm;
d is the internal diameter of the cylindrical filter, mm;
dₖ and Dₖ are the internal diameters of the upper and lower cross-sections of the conical filter, mm;
   k=0.12-0.14, mm/s, is the experimental coefficient for the material obtained with the spatial globular structure.

In doing so, the inlet surface of the main filtration element is covered by an additional filtration corrective protection layer of a finely grained substance introduced in the form of powder via a loading valve in the housing cavity into the flow of filtration liquid deposited on the inlet surface of the main filtration element and dynamically retained on it by the liquid velocity head, the powder granule size is greater than the size of ion-exchange material pores, and the additional volume being introduced into it, depending upon the main filtration element shape, is determined according to the following expressions:
V_{add}=HBΔ, mm², for the flat filter,
V_{add}=πHΔ(D+Δ, mm³, for the cylindrical filter;
V_{add}=πH(RΔ+rΔ+Δ²), mm³, for the conical filter,
where:
H is the filtration element height,
B is the filtration element width, mm;
D is the filtration element diameter, mm;
R is the radius of the lower conical base, mm;
r is the radius of the upper conical base, mm;
Δ is the required thickness of the protection layer, mm.

The filter can easily be made in various geometrical shape, which depends upon the housing design, for example, in the form of a hollow cylinder, a hollow cone, a plate or any other geometrical figure, as it is manufactured by casting into a mould. The optimal ratio of the of the inlet surface of the filter to its outlet surface equals to 1.6-2.6.

The volumetric reinforcement is made from a fibrous non-woven sheet material, for example, synthetic winteriser. As a filtration material of the protection additional layer, various substances are used depending upon the required correction of the composition of finished product, i.e. water. To this end, non-required and harmful substances are to be removed from the initial liquid to be filtered and then necessary and useful substances are to be added; water pH value shall be changes, if the main filter is not capable to do this. For example, using a chemically inert substance as the protection layer material, for example, perlite, we will in no way affect the composition of purified water. The additional layer performs the protection function only.

But if a chemically active substance if used as a filtration material of the additional layer, for example, resorcin-formaldehyde resin, then the purification functions of the additional layer will be enhanced.

Dolomite is used as a material of the additional protection layer correcting the pH value of water being filtered.

In order to protect filtered water from harmful microorganisms, a bacteriostatic substance, for example, active silver, is introduced into the material of the additional protection layer.

For the realisation of the filter design being declared, a filter manufacture method has been proposed, including preparation of the reaction mixture of polymer-forming reagents and conduction of the reaction with obtaining of the filtration element of the given shape, differing by the fact that at the reaction mixture preparation one shall first dissolve resorcin in water, then warm up the solution up to 40°-50° C., then introduce the catalyst, stir up and add formaldehyde after homogenisation of the solution, hold at the room temperature until the solution gets turbid; then the polymer solution obtained shall be poured into the mould, with the perforated support and the load-bearing reinforcement being preliminarily installed in it, such mould being made in the form of a sheet non-woven volumetric material laid in one or several layers and fixed on the perforated support; then the mould shall be thermostated in two stages: first the polymer is to be held until a gel is generated at the pouring temperature and after that at the temperature of 80°-95° C.; after cooling to the room temperature the porous ion-exchange element obtained shall be removed from the mould and placed into the filter housing, which is to be filled by a suspension of a finely grained hydrophilous powder, which granule size is greater that the size of ion-exchange element pores; the suspension shall be bubbled; an easily breakable additional protection corrective filtration layer shall be created on the inlet surface of the element by settling granules of the above-mentioned powder on the inlet surface of the element, and after its complete coverage by a layer of the given thickness, the layer shall be retained by the velocity head of the flow and after contamination the layer shall be removed by the back flow of the liquid.

The bubbling of the finely grained powder suspension is carried out by the flow of the liquid being filtered and/or by aeration of the liquid being filtered.

A distinctive peculiarity of the method is a possibility of regulation of the filter pore size, the ion-exchanging activity of the filter by changing the concentration of initial components. The mechanical strength of the main ion-exchange element as well as the content of formaldehyde in water are determined by the ratio of the number of cross-linking ether bonds to the number methylene bonds, It is well-known that the mechanical characteristics of a resorcin-formaldehyde substance are proportional to the amount of formaldehyde, which it releases, however an excessive amount of formaldehyde is not permissible in potable water. The authors have proposed the optimal ratio of the above-mentioned bonds, which does not permit any excess of its maximum permissible limits and is within the range of 0.8-1.2.

The optimal ratio of ingredients is given in the following table.

| Concentration | | Ratio of the | | Size of | |
|---|---|---|---|---|---|
| of polymer- | Formaldehyde/ | numbers of | | granules of | Thickness of |
| forming | resorcin | ether/ | Pore size | the protection | the protection |
| reagents, | ratio, | methylene | obtained, | layer powder, | layer, |
| mass. % | moles | bonds | μm | μm | μm |
| 50-40 | 2.5:1 | 1.2 | 0.001-0.02 | 0.03-0.3 | 0.01-0.05 |
| 40-35 | 2.0:1 | 1.15 | 0.02-0.2 | 0.3-4.0 | 0.05-0.2 |
| 35-25 | 1.8:1 | 0.9 | 0.2-0.3 | 4.0-10.0 | 0.2-1.0 |
| 25-20 | 1.5:1 | 0.8 | 3.0-8.0 | 10.0-25.0 | 1.0 and over |

As is known, ion-exchangers with the groups of —COOH and —OH are obtained as a result of the reaction of polycondensation of phenols with resorcin acid. Te exchanging capacity of ion-exchangers strongly depends upon the pH value of the solution [4]. The most effective pH area is within the pH range of 6-14. The typical property of ion-exchangers is their high selectivity to ions of H⁺ and a relatively high affinity to alkaline-earth metal ions. The selectivity series for metal ions have the reverse order as compared with strong acid ion-exchangers.

The selectivity series at pH 7 is as follows: Mg²⁺<Ca²⁺<Ni²⁺<Co²⁺<Cu²⁺;

The normal series is as follows: H⁺>Ca²⁺>Mg²⁺>Na⁺.

The essence of the ion exchange is that active groups are added into a neutral hydrocarbon polymer medium retaining positively charged ions (in the given case, sodium ions) due to its negative charge. When water contaminated, for example, by iron salt, is passing, the iron ions, due to their higher charge force out th sodium ions and occupy their place.

### BRIEF DESCRIPTION OF DRAWINGS

FIG. 1 shows the filter for water declared. It consists of the housing 1 equipped with the inlet 2, outlet 3 and drain 4 branch pipes with corresponding shutoff valves 5 and 6, the main filtration element 7 made from an ion-exchanging material in the form of a hollow cylinder, having the inlet 8 and outlet 9 surfaces for the liquid being filtered. The filtration element 7 has been armoured by the load-bearing reinforcement 10 attached to the perforated support 11. In doing so, the inlet surface 8 of the main filtration element 7 is covered by the additional filtration corrective protection layer 12 of a finely grained substance. The housing 1 is equipped with the loading valve 13.

FIG. 2 shows a filter with the conical filtration element, and FIG. 3 depicts a filter with the flat filtration element.

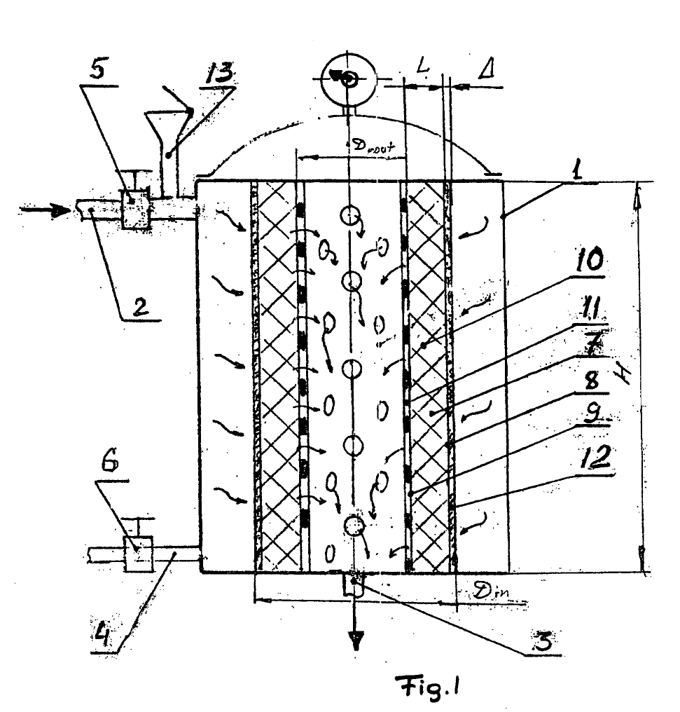

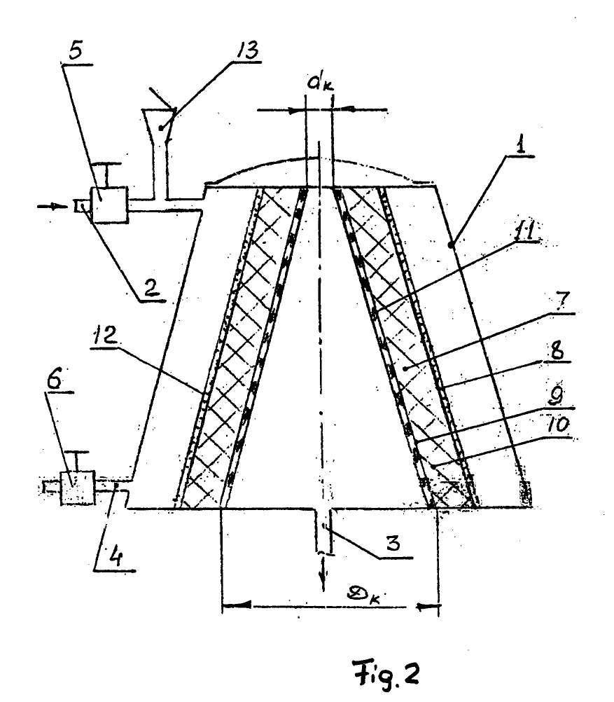

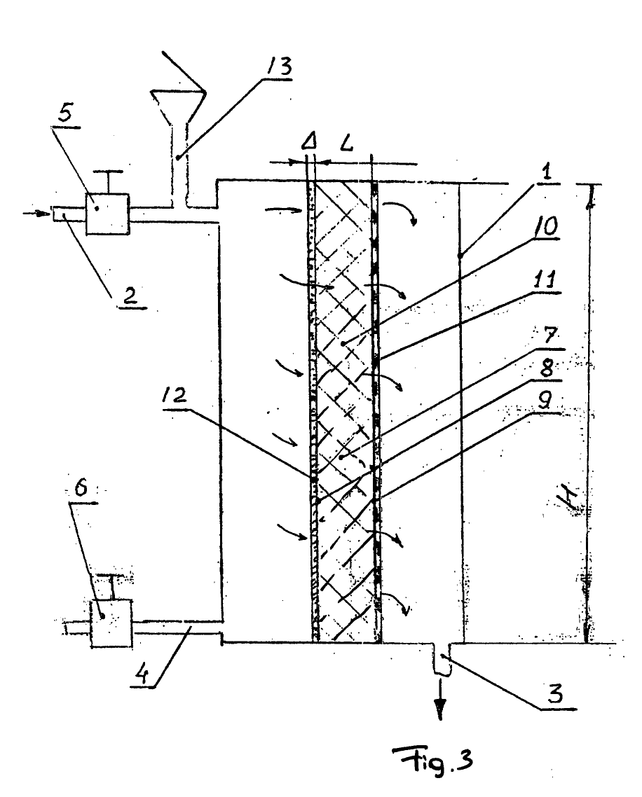

The device operates as follows.

After studying the nature of water contaminants, water being purified is supplied into the filter housing 1 though the inlet branch pipe 2, and depending upon the appearance of the contaminants the powder composition should be selected for the additional filtration corrective protection layer. The powder shall be poured into the cavity of housing 1 with the water being purified through the loading valve 13. The powder generates a suspension in the flow, which, while passing through the main filtration element 7, is settling on its inlet surface 8 with the generation of a protection layer of the identical thickness. Water, passing through the protection layer 12, which mechanically retains the main amount of impurities, is being preliminarily purified from harmful impurities and acquires necessary additives, then it follows through the main filtration element 7 where it is subjected to the ion exchange being finally purified and supplied to the user through the outlet branch pipe 3.

The design is especially effective at sudden salvo emission of contaminated water with a huge amount of contaminants. In this case, the protection layer 12 perceives the whole volume of contaminants, thus preventing poisoning of the main filtration element 7.

The filter regeneration is carried out by a back flow of water. To this end, the shutoff valve 5 on the inlet branch pipe 2 is to be closed and the valve 6 on the drain branch pipe 4 is to be opened. The contaminants being accumulated along with the protection layer shall be removed and the filtering properties of the filter shall be restored by means of filling of a new portion of the powder.

The Best Version of the Invention Implementation

The selection of the best version of the invention implementation shall be carried out on the basis of specific conditions to be determined by the composition of water being supplied to purification and by the required parameters of the finished product, i.e. potable water.

### EXAMPLE 1

### A Filter for Water Being Strongly Contaminated by Iron Salts

Load 420 ml of water, 130 g of resorcin, 140 ml of 37% formalin and 3 ml of hydrochloric acid (d=1.18) into the reactor. Stir up the reaction mixture at the temperature of 40° C. up to turbidity, pour into the mould, into which the volumetric reinforcement was preliminarily installed, thermostate the mould at 45° C. until the gel generation is completed (3 hours) and then at 80° C. during 24 hours. Upon cooling, remove the ion-exchange filtration elements with the pore size of 8 μm obtained, place it into the filter housing, which shall be filled with a suspension of the finely grained powder of resorcin-formaldehyde resin in water (the powder granule size of 20-25 pan, the particulate concentration is 5 g/l), by bubbling wash up a protection layer with the thickness of 1.9 mm on the inlet surface retaining it by the flow of liquid being filtered.

### EXAMPLE 2

### A Bacteriostatic Filter for Water Containing Hazardous Microorganisms

Load 410 ml of water, 120 g of resorcin, 370 ml of 37% formalin and 3 ml of hydrochloric acid (d=1.18) into the reactor. Add 300 mg of active silver. Stir up the reaction mixture at the temperature of 40° C. up to turbidity pour into the mould, into which the volumetric reinforcement was preliminarily installed, thermostats the mould at 45° C. until the gel generation is completed (3 hours) and then at 80° C. during 24 hours. Upon cooling, remove the ion-exchange filtration elements with the pore size of 0.001-0.02 μm obtained, place it into the filter housing, which shall be filled with a suspension of the finely grained powder of resorcin-formaldehyde resin in water (the powder granule size of 0.03-0.3 μm), by bubbling wash up a protection layer with the thickness of 0.01-0.05 mm on the inlet surface retaining it by the flow of liquid being filtered.

At the filtration of water contaminated by microorganisms, the suppression of the multiplication of filtered microorganisms takes place.

An example of calculation of the filtering mass volume.

Set the required performance of the filter: Q=10 l/min, the filtration layer thickness L=30 mm, k=0.12 mm/s, the head drop at the length of L equals to hᵥ=0.1 g/mm². Substituting the values taken into the above-mentioned formula for the cylindrical filter volume, calculate V=18.75 dm³.

### Industrial Applicability

The applicant has manufactured prototypes of the invention being declared. There are filtration elements of various geometrical shape: flat, in the form of hollow cylinders and cones. The most successful, from the point of view of design layout, have become cylindrical elements. The tests conducted have provide all advantages declared. In doing so, the following technical specifications have been achieved;
Maximal diameter: 75 mm
Height: 245 mm (for standard housings 10 inches);
   120 mm (for standard housings 5 inches).
It is possible to connect cartridges with threaded joints into cassettes:
   490 mm (for standard housings 20 inches);
   735 mm and over (for nonstandard housings).
Capacity: from 3 to 20 l/min (depends upon the porosity).
Maximal working pressure: 6 atm.
Maximal working temperature of water: up to 100° C.
Total resource: not less than 25 000 l.
Weight: not more than 0.8 kg.

The mechanical regeneration consists of the removal of filtered suspension from the filtration element surface (by a brush under a water jet in the domestic conditions or by backflow of water or compressed air in the event of industrial cleaning).

The chemical regeneration consists of the recovery of the sorption ability of the filtration element material during its treatment by acid.

Minimal value of a litre of purified water with the required quality of cleaning due to a possibility of multiple regeneration of the filtration element.

Possibility of Hot Water Filtration

The self-indication of the necessity of regeneration is determined by the reduction of the purified water flow.

Possibility of using filters with different properties: various porosity and performance, for “soft” and “hard” water, for water with an increased content of dissolved iron, etc.

Effectiveness of Cleaning
Suspended particles>1 μm—up to 98%
Microbes and colibacillus—up to 99.9%
Heavy metals—up to 99%
Organic compounds and chlorine—up to 96%
Hardness salts*—up to 90%
   *The ion-exchange filter for hard water is capable to remove from water up to 12 g of calcium and up to 8 g of dissolved iron, after which chemical regeneration is required. The regeneration process frequency depends upon the hardness of water and upon the concentration of dissolved iron in purified water.

The material uniqueness consists of the fact that even after saturation by hardness salts it changes their structure no removing them from water so that water having passed through the filter gives no sediments and scale.

| | Material pore size, μm | | | | | | |
|---|---|---|---|---|---|---|---|
| Technical specifications | 0.05-0.1 | 0.1-0.5 | 0.5-1.0 | 1.0-0.5 | 1.5-2.0 | 2.0-3.0 | 3.0-4.0 |
| Performance, l/min | 3-5 | 6-8 | 9-11 | 12-15 | 16-20 | 20-30 | 30-40 |
| Effectiveness of cleaning from | | | | | | | |
| pathogenic microbes, % | | | | | | | |
| Colibacillus | 99.9 | 99 | 97 | 90 | 75 | 58 | 50 |
| Coli-fags | 99.9 | 98.5 | 90 | 80 | 70 | 50 | 35 |
| Penetration of viruses through | | | | | | | |
| the filter | | | | | | | |
| Hepatitis A | No | No | No | Yes | Yes | Yes | Yes |
| Rotoviruses | No | No | No | No | Yes | Yes | Yes |

### REFERENCES

1. Useful model No. 818, 1993. Filter for additional purification of potable tap water.
2. Author's Certificate No. 715501, 1980, A method for the production of a micropore polymer filter.
3. Author's Certificate No. 1162822, 1980. A method for the production of moulded materials based on urea-formaldehyde resin.
4. M. Marhol. Ion-exchangers in analytical chemistry. Part 1.—M.: Mir, 1985.
5. Mainline filters. Geyser-32 Filter. Operating Instruction.—St Petersburg, 2000 (a prototype).

1-17. (canceled)

18. A filter for water, comprising a housing provided with an inlet branch pipe, an outlet branch pipe and a drain branch pipe with shutoff valves; a main filtration element composed of an ion-exchange material and having inlet and outlet surfaces for a liquid being filtered, said ion-exchange material of said main filtration element being volumetric with a predetermined geometric shape, is armored by a load-bearing reinforcement attached to a perforated support and forming a continuous porous framework of microglobules with pores of predetermined size in correspondence with parameters of cleaning, wherein the filtration mass volume of the material of said main filtration element is determined according to the follows expression:
$${V}_{fl} \frac{Q \cdot {L}^{2}}{k \cdot {h}_{v}}$$
For a flat filter
$${V}_{cyl} = \frac{Q \cdot {L}^{2} ( L + d )}{k \cdot {h}_{v} \cdot d}$$
for a hollow cylindrical filter;
$${V}_{co n} = \frac{Q \cdot {L}^{2} ( 2 L + {d}_{k} + {D}_{k} )}{k \cdot {h}_{v} ( {d}_{k} + {D}_{k} )}$$
—for a conical filter;
where Q is a required flow rate of the liquid being purified, kg/s;
L is a filtering layer thickness, mm;
d is an internal diameter of the cylinder filter, mm;
dₖ and Dₖ are internal diameters of an upper and a lower cross-section of the conical filter, mm;
k=0.12-0.14 mm/s, is an experimental coefficient for the material with a spatial globular structure make;
an additional filtration correction protection layer covering an inlet surface of said main filtration element and composed of a finely grained substance introduced in form of powder via a loading valve in a housing cavity into a flow of filtration liquid deposited on said inlet surface of said main filtration element and dynamically retained on it by a liquid velocity head, so that a powder granule size is greater than a size of ion-exchange material pores, wherein an additional volume introduced depending upon a shape of the main filtration elements determined according to a following expression
V_{add}=HBΔ, mm² for a flat filter;
V_{add}πHΔ(D+Δ), mm³, for a cylindrical filter;
V_{add}=H(RΔ+rΔ+Δ²), mm³ for a conical filter;
where H is a filtration element height; mm
B is a filtration element width; mm
D is a filtration element diameter, mm;
R is a radius of a lower conical base, mm;
r is a radius of an upper conical base, mm;
Δ is a required thickness of the protective layer, mm.

19. A filter for water as defined in claim 18, wherein the filter is formed as a hollow cylinder.

20. A filter for water as defined in claim 18, wherein the filter has an inlet surface and an outer surface with a ratio of said inlet surface to said outlet surface equal to 1.6-2.6.

21. A filter for water as defined in claim 18, wherein the filter is formed as a cone.

22. A filter for water, as defined in claim 18, wherein said filter is formed flat.

23. A filter for water as defined in claim 1, wherein said volumetric reinforcement is composed of a fibrous non-woven sheet material.

24. A filter for water as defined in claim 23, wherein said fibrous non-woven sheet material is a synthetic winterizer.

25. A filter for water as defined in claim 18, wherein said protection additional layer is composed of a filtration material which is a chemically active substance.

26. A filter for water as defined in claim 25, wherein said chemically inert substance is perlite.

27. A filter of water as defined in claim 18, wherein said filtration material of said protective additional layer is composed of a chemically active substance.

28. A filter of water as defined in claim 27, wherein said chemically active substance is resorein-formaldehyde resin.

29. A filter of water as defined in claim 18, wherein said additional protective layer has a material which corrects pH value of water being filtered and is composed of dolomite.

30. A filter of water as defined in claim 18, wherein said additional protection layer is composed of a material with inclusion of a bacteriostatic substance.

31. A filter of water as defined in claim 30, wherein said bacteriostatic substance is active silver.

32. A method of manufacturing a filter, comprising the steps of preparing a reaction mixture of polymer-forming agents; conducting a reaction with obtaining a filtration element of a predetermined shape; during the preparing the reaction mixture first dissolving resorein in water, then warming up a solution up to 40°-50° C., then introducing a catalyst, steering up and adding formaldehyde after homogenization of the solution, holding at a room temperature until the solution gets turbid; pouring the obtained polymer solution into a mold with a perforated support and a load-bearing reinforcement being preliminarily installed in the mold; using the mold in form of a sheet non-woven volumetric material and fixed on a perforated support; thermostating the mold in two stages: first a polymer is to be held until a gel is generated at a pouring temperature and after that at a temperature of 80°-90° C.; after cooling to a room temperature removing the porous ion-exchange element obtained from the mold and placing into a filter housing; filling the filter housing with a suspension of a finely grained hydrophilous powder containing substances correcting properties of filtered water with a granule size greater than a size of ion-exchange element pores; bubbling the suspension; creating an easily breakable protection corrective filtration layer on an inlet surface of the filtration element by settling granules of the powder on an inlet surface of the element; and after its complete covering by a layer of a given thickness, retaining the layer by a velocity head of a flow; and after contamination removing the layer by a backflow of the liquid.

33. A method as defined in claim 32; and further comprising carrying out the bubbling of the suspension of a finely grain powder by a flow of a liquid being filtered.

34. A method as defined in claim 32; and further comprising carrying out the bubbling of the suspension by aeration of the liquid.

35. A method as defined in claim 32; and further comprising for obtaining an element pore size equal to 0.001-0.02 μm, taking an initial concentration of the polymer forming agents to be 50-40 mass % and a ratio of formaldehyde resorein equal to 2.5-1 moles, with a ratio of a number of cross-linking ether bonds to a number of methylene bonds being equal to 1.2, and for generation of the protection layer taking a powder granule size equal to 0.03-0.3 μm and a thickness of the protection layer of 0.01-0.5 μm.

36. A method as defined in claim 32; and further comprising for obtaining an element pore size equal to 0.02-0.2 μm, taking an initial concentration of polymer-forming reagents to be 40-35 mass % and a ratio of formaldehyde-resorein equal to 2.0-1 moles, with a ratio of a number of cross-linking ether bonds to a number of methylene bonds being equal to 1.15; and for generating the protection layer taking a powder granule size equal to 0.3-4.0 μm and a thickness of the protection layer to be equal to 0.05-0.2 μm.

37. A method as defined in claim 32; and further comprising for obtaining an element pore size equal to 0.2-0.3 μm, taking an initial concentration of polymer-forming reagents to be 35-25 mass % and a ratio of formaldehyde-resin equal to 1.8-1 moles as a ratio of a number of crosslinking ether bonds to a number of methalene bonds being equal to 0.9; and for generation of the protective layer, taking a powder granule size to be equal to 4.0-10.0 μm and a thickness of the protection layer to be equal to 0.2-1.0 μm.

38. A method as defined in claim 32; and further comprising, for obtaining an element pore size equal to 3.08.0 μm, taking an initial concentration of polymer forming reagents to be 25-20 mass % and a ratio of formaldehyde-reserin equal to 1.5-1 moles, with a ratio of a number of cross-linking ether bonds to a number of methylene bonds being equal to 0.8; and for generating the protection layer, taking a powder granule size equal to 10.0-25.0 μm and a thickness of the protection layer equal to to be 1.0 μm and over.
